(19) United States
(12) Patent Application Publication
(10) Pub. No.: US 2006/0197972 A1
(43) Pub. Date: Sep. 7, 2006

(54) Image forming device, image processing system, storage medium for storing printer driver, and image reading device

(75) Inventor: Shinji Hayashi, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/164,596

(22) Filed: Nov. 30, 2005

(30) Foreign Application Priority Data
Nov. 30, 2004 (JP) 2004-347845
Nov. 30, 2004 (JP) 2004-347855

(51) Int. Cl. G06K 15/00

(52) U.S. Cl. 358/1.14; 358/296

(57) ABSTRACT

By attaching copy output restriction information for restricting copy output according to predetermined user information onto recording paper in conjunction with image data at the time of the image forming process, authorized and prohibited copy output settings are can be set for individual users even if the document has copy output restriction information attached. In this way, a general user with authorization for copy output is prohibited, for example, from copy output of a document while a manager can be authorized for copy output by performing detailed copy authorization settings.

### BACKGROUND OF THE INVENTION

1. Field of the Invention

The present invention relates to so-called copy guard functionality for preventing illegal copying of documents by image forming devices, image reading devices, and the like, and especially to technology that implements high usability copy guard functionality by providing copy restrictions according to the operator who is copying a document.

The present invention further relates to so-called copy guard functionality for preventing illegal copying of documents by image forming devices, image reading devices, and the like, and especially to technology that implements the copy guard functionality by using unique information contained in a document.

2. Background Information

Conventional functionality to prevent illegal copying of a document is known, as described in Japanese Published Patent Application No. 2000-165575, which attaches a copy prohibition mark (pattern) or a copy authorization mark (pattern) in advance to a document in order to prohibit or authorize copy output (printing output) and the reading of a document image in accordance with the existence of the given mark at the time the document image is read (referred to as copy guard functionality and copy protection functionality).

Recently, as the problem of illegal copying of written works and paper currency spreads, various technologies have been proposed using copy guard technology. For example, in Japanese Published Patent Application No. 2001-215852, technology is disclosed which embeds visible duplicate prohibition information and invisible duplicate prohibition information into image data (electronic data) prior to printing output. In Japanese Published Patent Application No. 2003-8864, technology is disclosed for restricting new reproduction based on a previous duplication, i.e. secondary reproduction, by assigning a copy prohibition pattern to the duplicated material of the document.

However, there is poor usability with conventional copy guard functionality, including the technology described above, from the perspective of the user using copy guard functionality. This is because copy output of a document having a copy authorization mark is authorized impartially, and copy output for a document having a copy prohibition mark is also prohibited impartially. For example, even though the authors of electronic data, such as written data and image data, and the managers thereof are privileged users capable of using these electronic data relatively freely, the inconvenience persists where copy authorization or prohibition settings cannot be executed by individual users of electronic data. There is further inconvenience, in that although the author of the electronic data can obtain a document with a copy prohibition setting by printing the electronic data, the manager is restricted from printing such document, and cannot obtain a document without making a specific request of the author of the electronic data for a printout.

A further problem with conventional copy guard functionality, including the technology described above, is that it is possible to copy prohibited documents having, for example, a copy authorization mark cut and pasted from another document in a system where only documents having a copy authorization mark are authorized to be copied. There is also the problem that copy prohibited documents which have the copy prohibition mark removed are easily copied in a system where only documents having a copy prohibition mark are prohibited from being copied. The problem is extremely significant because the copy guard is not applied to the duplicated material obtained through illegal copying when this type of illegal copying is performed, which encourages proliferation of the duplicated document. Of course, one method that can be conceived to eliminate this type of problem is to use an extremely complicated mark, but that does not resolve the fact that copying of a copy prohibited document is still possible by either removing or pasting such mark.

An object of the present invention is to provide copy guard functionality with high usability by performing copy authorization or prohibition settings for a document by individual users of the document.

Another object of the present invention is to provide more advanced copy guard functionality, which accurately discriminates between authorized and prohibited copies by making possible a determination of the legality of the mark included in the document image by using unique information of a document as a mark attached to the document to allow or prevent copying of the document.

### SUMMARY OF THE INVENTION

The present invention, in order to achieve these objectives, is applied to an image forming device, such as a printer, for performing an image forming processes which form image data on recording paper, and is constituted to attach copy output restriction information for restricting copy output according to predetermined user information onto recording paper in conjunction with image data at the time of the image forming process. In this way, authorized and prohibited copy output settings are possible for individual users even if the document has copy output restriction information attached, and as a result, a general user with authorization for copy output is prohibited from copy output of a document, while a manager can be authorized for copy output by performing detailed copy authorization settings. In this way, usability can be improved for users of documents.

Authority information concerning copy output having an assigned rank according to predetermined user information is included here as conceivable copy output restriction information. By using authority information having an assigned ranking in this manner, authorization or prohibition copy output settings can be easily made.

Information unique to the image data may also be included in the copy output restriction information.

The present invention has a system architecture for generating copy output restriction information to restrict copy output according to predetermined user information, and for attaching the generated copy output restriction information onto recording paper in conjunction with image data at the time of the image forming process when perceiving an image processing system providing an image forming device and an information processing control device for controlling the image forming process for image data output to the image forming device. Moreover, generation of copy output restriction information may be performed by either the image forming device side or the information processing control device side.

In this case, a structure can be conceived in which the copy output restriction information can be generated according to advisability settings for generating copy output restriction information determined by the printer driver in the information processing control device through operation by an operator.

The present invention is further perceived as a storage medium for storing a printer driver to control the image forming process in the image forming device. In other words, a structure may also be provided as a storage medium for storing a printer driver which implements a copy output restriction information generation advisability setting function for setting the advisability of generating copy output restriction information to restrict copy output according to predetermined user information, and a copy output restriction information generation function for generating the copy output restriction information according to the setting by the copy output restriction information generation advisability setting means. By composing in such a manner, settings as to whether to attach copy output restriction information to the printed material or not can be performed easily through software.

The present invention is applied here to an image reading device controlled to recognize use by a user only when login information that matches user information registered in advance is input, and it may be perceived as an image reading device such as a scanner or the like constructed to determine whether copy output restriction information is attached to the read image data in order to restrict the copy output according to the user information; and to determine the advisability of copy output in the image forming device based on the attached copy output restriction information and the input login information when it has been determined that copy output restriction information is attached. In this way, a user authorized to copy (for instance, a manager) has the ability to copy even when copying a document having copy output restriction information attached enabling copy restriction to be provided to individual users because copying is prohibited for a user prohibited from copying (for instance, a general user). Moreover, the copy output restriction information is preferred to include authority information concerning copy output assigning rank according to user information.

When perceiving the present invention as an image forming device that provides an image reading device, an image forming device can further be conceived that equips a copy output restriction means for executing a copy output restriction process according to the determination result by the copy output advisability determination means in regards to image data read by the image reading device. In this way, normal copy output is possible, for example, by a manager being authorized to copy while a copy output prohibition process is possible for a general user prohibited from copying and a process for executing a draft printing process or a solid black printing process also becomes possible.

The present invention, in order to achieve these objectives, is applied to an image forming device, such as a printer, for performing an image forming process to form input image data on recording paper, and is structured to attach copy guard information that includes unique information to at least the image data onto the recording paper in conjunction with the image data at the time of the image forming process. In this way, copy guard information that is unique to the printed material, i.e. a document, obtained by an image forming process becomes attached, and as a result, accurate discrimination is possible between authorized and prohibited copies of a document by executing a comparative determination for a match or non-match of the unique information calculated from image data of the document read by the copying machine with the unique information that includes the copy guard information attached to the document. In this way, illegal copies can be reduced enabling the implementation of high performance copy guard functionality.

Copy guard information can here be conceived to include identification information of the image forming device in addition to unique information. If this type of copy guard information is attached to the document, copy output can be prevented by a copying machine that does not match with this identification information.

The copy guard information may further be copy prohibition information and copy authorization information. Regardless of either information, the effect as copy guard functionality is demonstrated. Of course, both copy prohibition information and copy authorization information may be included in the copy guard information.

The unique information can be conceived to be checksum data, hash value, edge number, or pixel density total values (gradient) or the like derived from the image data. Of course, a plurality of these unique information types may also be used in combination.

Further, because the specific location of the attached information is difficult to place, the copy guard information is preferred to attach each type of information (identification information and unique information) included in the copy guard in a single or a plurality of predetermined areas on the recording paper. In addition, the most preferred form would be for the copy guard information to be invisible information implemented by an electronic watermark or the like.

When perceiving the present invention as an image processing system that provides an image forming device and an information processing control device for controlling the image forming process in regards to image data output to the image forming device, such system architecture can be structured to generate copy guard information that includes unique information of at least the image data, and attaches the generated copy guard information onto the recording paper in conjunction with the image data at the time of the image forming process. Moreover, the generation of the copy guard information can be performed by either the image forming device or the information processing control device.

In this case, a construction can be conceived in which the copy guard information is generated according to settings for the advisability of generating copy guard information determined by printer drivers in the information processing control device through the operation of an operator.

The present invention is also perceived as a storage medium for storing a printer driver to control the image forming process in the image forming device. In other words, a structure may also be provided as a storage medium for storing a printer driver which implements a copy guard information generation advisability setting function for setting the advisability of generating copy guard information that includes unique information of at least the image data, and a copy guard information generation function for generating the copy guard information according to the setting by the copy guard information generation advisability setting means. By structuring in such a manner, settings as to whether to attach copy guard information to the printed material or not can be performed easily through software.

The present invention is perceived here as an image reading device, such as a scanner, constructed to determine whether copy guard information is attached to the image data read by scanning the image printed surface of a document, and to determine the legality of the copy guard information when it is determined by this determination that copy guard information is attached. In this way, the legality of copy guard information can be denied when reading a document image that has been cut and pasted from the copy guard information of another document. Processing for this denied document image can be terminated (cancelled), or such read image data can be deleted or the like enabling the effective prevention of illegal copies based on illegally read image data. In this way, more high performance copy guard functionality can be realized.

A specific method for determining legality can here be conceived to detect from the read image data, information for determining legality (information detection means for determining legality) that includes unique information to at least the image data, and determining whether the unique information that includes the detected information for determining legality matches with the unique information calculated from the read image data.

The legality determination means also further determines whether the identification information included in the copy guard information matches with the identification information of the image forming device when the identification information of a predetermined image forming device is included in the copy guard information. In this way, illegal copies can be effectively reduced by, for example, authorizing only copy output in only the matching image forming device and restricting, by prohibiting or the like, copy output by any other image forming device.

When perceiving the present invention as an image forming device that provides an image reading device, an image forming device can be conceived that equips a copy guard processing means that performs a copy guard process according to the determination result by the legality determination means in regards to image data read by the image reading device. In this way, when copy guard information is copy authorization information, a copy output process can be executed when it is determined to be legal, and a copy output prohibition process, a draft printing process, or a solid black printing process (any being an example of a copy guard process) or the like, can be executed when it is determined to be not legal. Of course, when the copy guard information is copy prohibition information, a copy output prohibition process or the like can be executed when it is determined to be legal and a copy output process can be executed when it is determined to be not legal.

The present invention can further be conceived to be constructed to generate secondary copy guard information that differs from the copy guard information in conjunction with deleting the copy guard information attached to (included in) the read image data when copy output (the image forming process) is authorized, and to attach the generated secondary copy guard information onto the recording paper in conjunction with the read image data at the time of the image forming process. Due to advances in image formation technology in recent years, there are cases in which image quality which compares favorably to an original document can be provided even when the document is a duplicate. In this case, the unique information of the document can be considered to match with the unique information of the duplicate. Therefore, by creating a clear difference between the copy guard information of the original document and the copy guard information of the duplicate (secondary copy guard information), illegal copying of a document can be prevented by attaching or deleting the copy guard information. Moreover, the secondary copy guard information can conceivably also contain identification information of the image forming device or unique information of the read image data in the same manner as the copy guard information.

According to the present invention, authorized and prohibited copy output can be set to individual users even if copy output restriction information is attached because the copy output restriction information for restricting copy output according to predetermined user information is attached to the recording paper in conjunction with the image data at the time of the image forming process. In this way, for instance, a general user with authorization for copy output is prohibited from copy output of the document while a manager can be authorized for copy output by performing detailed copy authorization settings. In this way, usability can be improved for users of documents.

The illegality of copy guard information can be determined by executing a comparative determination for a match or non-match of the unique information computed from image data of the document read by, for example, a scanner, copying machine, or the like, with the unique information that includes the copy guard information attached to the document because copy guard information that is unique to the document is attached to the printed material, i.e. the document, obtained by the image forming process in an image forming device such as a printer or the like. In this way, authorized or prohibited copy output of a document can be accurately discriminated, and as a result, illegal copies can be reduced enabling high performance copy guard functionality to be realized.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram that depicts a schematic composition of system X as well as a terminal device X1 and printer X2 comprising same that relates to the first embodiment of the present invention;

FIG. 2 is a flowchart that describes one example of the order of the copy authorization mark attachment process executed by the CPU of the terminal device X1;

FIG. 3 is a flowchart that describes one example of the order of the copy authorization mark generation process executed by the CPU of the terminal device X1;

FIG. 4 is a drawing that shows the area for integrating and attaching the copy authorization mark;

FIG. 5 is a schematic cross sectional drawing that describes the schematic composition of the copying machine X4 that relates to the second embodiment of the present invention;

FIG. 6 a block diagram that shows the schematic composition of the main control unit of the copying machine X4 that relates to the second embodiment of the present invention;

FIG. 7 is a flowchart that describes one example of the order of the copy authorization determination process executed by the CPU of the main control unit of the copying machine X4 that relates to the second embodiment of the present invention;

FIG. 8 is a flowchart that describes another example of the order of the copy authorization determination process executed by the CPU of the main control unit of the copying machine X4 that relates to the second embodiment of the present invention;

FIG. 9 is a table diagram that regulates the copy authorization levels and the copy prohibition levels according to the user level;

FIG. 10 is a flowchart that describes the order of a modified example of the copy authorization mark attachment process; and

FIG. 11 is a flowchart that describes the order of a modified example of the copy authorization determination process.

### DETAILED DESCRIPTION OF THE PREFERRED EMBODIMENTS

Descriptions of embodiments of the present invention will be given hereafter with reference to the attached drawings to provide an understanding of the present invention. Moreover, the embodiments to be described hereafter are simply examples, and do not restrict the scope of the present invention.

### First Embodiment

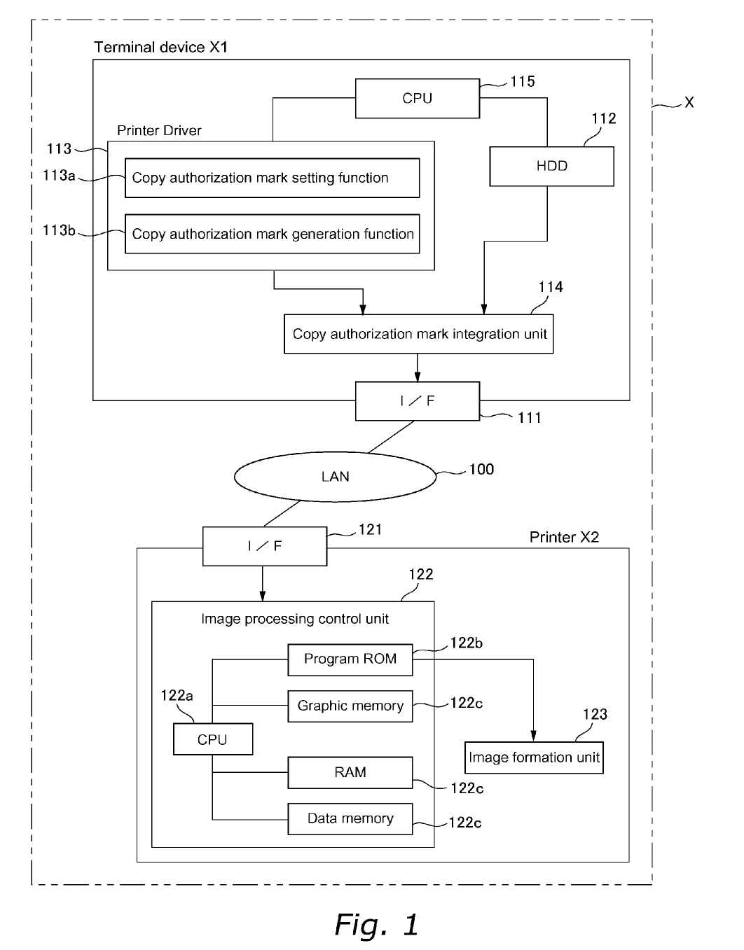

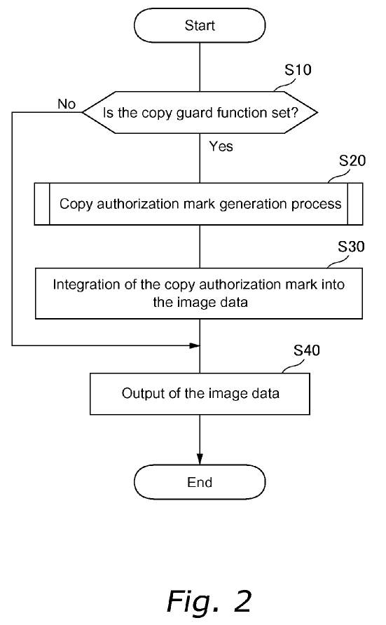

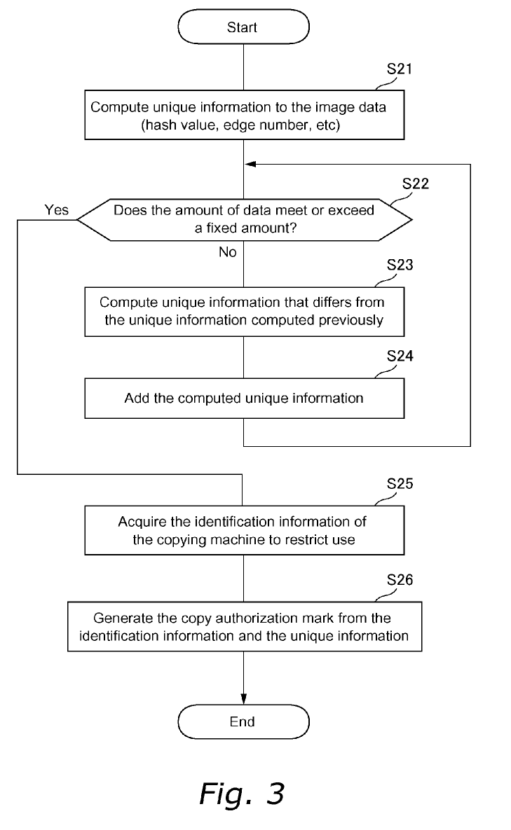

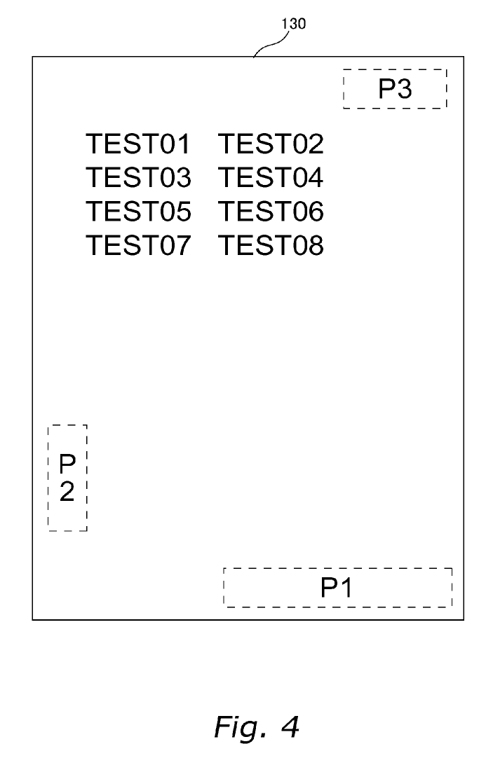

A description is first provided hereafter with reference to FIG. 1 through FIG. 4 of the image processing system X (hereinafter abbreviated as “system X”) that relates to the first embodiment of the present invention. Moreover, a description is provided herein of an example of attaching (printing) a copy authorization mark (corresponding to the copy authorization information), which is one example of copy guard information, onto recording paper. Herein, FIG. 1 is a block diagram which depicts a schematic composition of system X as well as a terminal device X1 and printer X2 comprising same; FIG. 2 is a flowchart which describes one example of the order of the copy authorization mark attachment process executed by the CPU of the terminal device X1; FIG. 3 is a flowchart which describes one example of the order of the copy authorization mark generation process executed by the CPU of the terminal device X1; FIG. 4 is a drawing that shows the area for integrating and attaching the copy authorization mark.

System X, as shown in FIG. 1, is constructed under a communication environment capable of data communications by connecting a terminal device X1, such as a personal computer or PDA or the like, which serves as one example of an information processing control device, and a printer X2, which serves as one example of an image forming device, through a LAN 100. Although this first embodiment provides a description of an example where only the terminal device X1 and the printer X2 are connected, it is not particularly restricted to this, and a system architecture connecting, for example, a plurality of terminal devices with a plurality of printers in an office or the like with various other network apparatus through a network such as a LAN or the like, may also be applied to the present invention.

The printer X2 is a device which executes an image forming process, i.e. printing process (printout process), to form input image data from the terminal device X1 onto printing paper supplied within the printer X2, and corresponds to, for example, a laser printer, ink jet printer, or the like. Of course, this may also be a multi-function device (MFP) that provides a variety of functions such as printing functionality, copy functionality, facsimile functionality, or the like.

The printer X2, as shown in the drawing, is constructed in outline of a LAN connection I/F 121 such as a LAN adapter which enables the connection to the LAN 100, an image processing control unit 122 to control and execute a process for converting the input image data to printable data by the printer X2 and various image processes according to printing conditions, and an image formation unit 123 for transcribing (forming) a visible image (for example, toner image) according to image data processed by the image processing control unit 122.

The image processing control unit 122 is constructed of known control mechanisms, and is more specifically constructed by providing a CPU 122a , a program ROM 122b that stores a program necessary for image processing, graphic memory 122c which stores or temporarily saves image data, RAM 122d used as development area for image data or so forth at the time of image processing, and data memory 122e which stores various data. Of course, the construction is not limited to these control mechanisms and can be composed by, for example, an integrated circuit such as an internal memory ASIC or the like.

The terminal device X1, as shown in the drawing, is constructed by providing control mechanisms such as a LAN connection I/F 111 which enables the connection with the LAN 100, an HDD 112 which stores the image data such as written data or graphic data, a printer driver 113 which controls the image forming process (printing process) by the printer X2 for the image data output to the printer X2, a copy authorization mark integration unit 114 for integrating the copy authorization mark to be described below to the output image data, a CPU 115 which unifies and controls the terminal device X1, and RAM not shown in the drawing.

The printer driver 113 is software which is embodied by a program stored in ROM or the like being read and executed by the CPU 115. The printer driver 113 provides a copy authorization mark setting function 113a (corresponding to copy guard information generation advisability setting function) which sets the advisability for generating the copy authorization mark which includes unique information to the image data output from the terminal device X1 to the printer X2 at the time of executing printing output, i.e. the copy guard setting function, and copy authorization mark generation function 113b (corresponding to copy guard information generation function) which generates the copy authorization mark according to the above setting. Moreover, the copy authorization mark setting function 113a is implemented, for example, by selecting items which decide the advisability of generating the copy authorization mark arranged in the known printing condition setting screen (called the properties screen, driver utility screen, and so forth) in the printer driver 113. A description will be provided below of the copy authorization mark generation function 113b with reference to FIG. 2.

The copy authorization mark integration unit 114 is an integrated circuit providing a function for integrating the copy authorization mark generated by the printer driver 113 with the image data read from the HDD 112, and more specifically, it is composed of a hardware mechanism such as an IC. Of course a composition that allows the above integration to be executed over software by the CPU 115 is also acceptable.

The copy authorization mark is printed on recording paper in conjunction with image data at the time of being printed out by the printer X2 and is a mark for authorizing copies (reproductions, duplications) of printed out printed material. With this first embodiment, copies are authorized for only printed materials with this copy authorization mark attached, while copies of printed material without the copy authorization mark attached are defined as prohibited. Moreover, many varieties of copy authorization marks can be conceived with details to follow hereafter.

A description is provided herein of one example of the order of the copy authorization mark attachment process executed by the CPU 115 using flowchart FIG. 2 with reference to block diagram FIG. 1. References S10, S20, etc. in FIG. 2 indicate process order (step) numbers. The copy authorization mark attachment process begins with step S10.

An operator sets predetermined printing conditions in the printer driver 113, and afterwards, when a print out operation is executed for image data, the process after step S10 is executed before image data is output to the printer X2.

At step S10, the CPU 115 determines here whether the advisability for generating the copy authorization mark is set based on whether the copy guard function is set in the printer driver 113 (more specifically, the copy authorization mark setting function 113a ).

If it is determined here that the copy guard function is not set, then the process proceeds to step S40, and image data is output to the printer X2 without attaching (integrating) a copy authorization mark to the image data. In other words, normal printing is executed.

Conversely, if it is determined that the copy guard function is set, the process proceeds to step S20. At step S20, a copy authorization mark is generated. The applied process for this will be described hereafter.

After a copy authorization mark his generated at step S20, the process for integrating and attaching the generated copy authorization mark to the print out image data is executed at the following step S30 by the copy authorization mark integration unit 114. The copy authorization mark is integrated and attached to the image data 130 shown in FIG. 4 at, for example, the area P1 of the lower right side of the image data 130. In the case where the copy authorization mark consists of a plurality of information (such as the identification information of the output printer and the unique information to the image data), all of the plurality of information need not be attached to the area P1 but can be attached, for example, by dispersing between other areas P2 and P3 shown in FIG. 4.

Visible images consisting of, for example, barcodes, encoded symbols or character strings, were the like, as well as invisible images such as an electronic watermark can also be applied to the copy authorization mark. At such time when using, for example, a visible image copy authorization mark, integrating and attaching the copy authorization mark near the edge of the image data (for instance, areas P1, P2, and P3) where written text or the like is not recorded (low density or gradient) is preferred; however, when using an invisible copy authorization mark, integrating and attaching the electronic watermark or the like by disappearing it into an area where written text or images are recorded (high density or gradient) is preferred.

At step S40 the image data that has been integrated and attached with a copy authorization mark is output to the printer X2.

Image data output in this manner is input into the printer X2 and printed on recording paper with image data having a copy authorization mark attached at the time of the printing process by the printer X2.

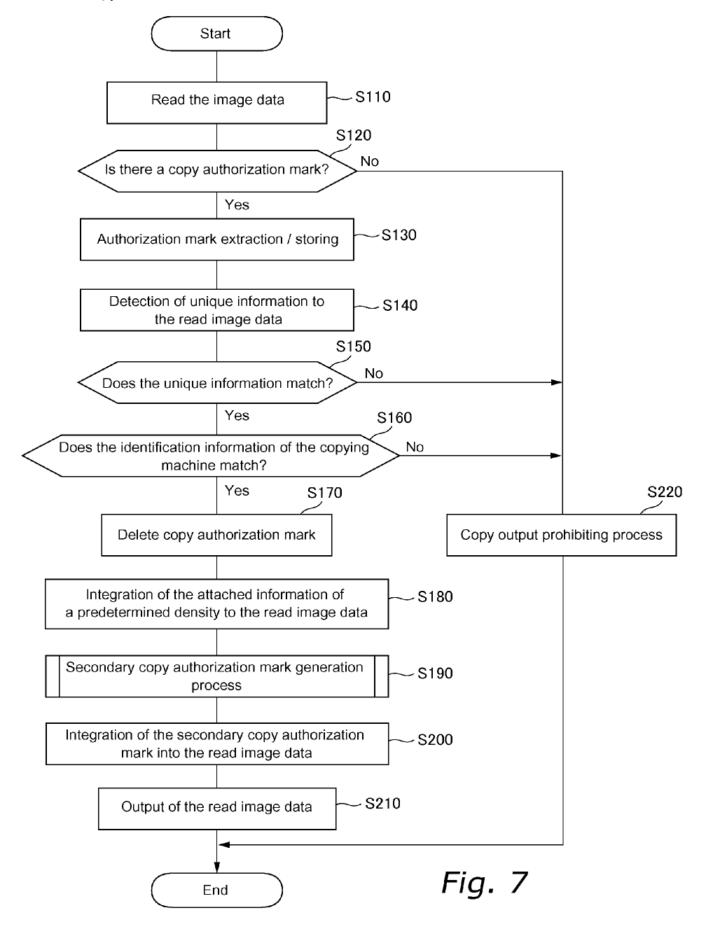

Copying can be prevented in this manner through the copy authorization determination process (see FIG. 7) to be described hereafter even if this mark is temporarily pasted to a copy prohibited document because information unique to the printed material obtained through the printing process is attached as a copy authorization mark.

A description will be given next of one example of the order of the copy authorization mark generation process executed by the CPU 115 using the flowchart in FIG. 3. The process begins from step S21.

At step S21, unique information held by the image data is computed by the CPU 115. This unique information can be various data including checksum data, hash value, edge number, or pixel density total value derived from the image data and can be data computed from any of these. However, at step S21, the hash value and edge number are computed from the above unique information.

After the hash value and edge number are computed, it is determined at the next step S22 whether these unique information has a data amount that meets or exceeds a pre-determined fixed amount. This is the determination process executed for considering that there may be insufficient information amount for the computed unique information to be used as a copy authorization mark if the information amount of the image data itself is insufficient. If it is determined here that it meets or exceeds the fixed amount, then the process proceeds to step S25. On the other hand, if it is determined that it does not meet the fixed amount, then unique information (for example, checksum data) that differs from the previously computed unique information (herein being the hash value and the edge number) is further computed (S23), and the computed checksum data is added (S24) to the previously computed unique information and then the process at step 22 is repeated again.

After the process proceeds to step 25, the process for acquiring the unique information of the copying machine (not shown in the drawing) which restricts copy output is performed. For example, when a plurality of MFP are connected to a LAN in the LAN 100 in an office, such acquiring can conceivably be done by accessing a designated MFP through the LAN 100. Of course, the identification information of a plurality of copying machines and MFP stored in advance in the memory of the terminal device X1 is sufficient if acquiring identification information of an MFP which restricts use from the memory. Moreover, an IP address automatically assigned for network connection and an ID code or the like artificially determined in advance can be used as the identification information.

At the next step S26, a copy authorization mark is generated from the identification information and unique information. Various forms can be conceived as the mark generated at this time including, for example, a barcode, a watermark, or something which combines the unique information and identification information according to a predetermined algorithm (rule).

The description given of the first embodiment given above describes an example for output to the printer X2 after integrating and attaching a copy authorization mark to image data by generating a copy authorization mark in a terminal device X1; however, it is not limited to that. An embodiment can be given, for example, of performing a process for output of the setting information to the printer X2 together with the image data at the terminal device X1 side, while the copy authorization mark generation process (FIG. 2) of the previous step S20, and integration and attachment process of the copy authorization mark of the previous step S30, can be performed based on the input setting information at the printer X2 side. In this case, the substantive processing of the integration and attachment process and the copy authorization mark generation process become part of the image processing control unit 122 (the CPU 122a ).

The first embodiment described above gives an example of using the copy authorization mark as one example of copy guard information; however a copy prohibition mark (corresponding to copy prohibition information) is of course also one example of copy guard information.

### Second Embodiment

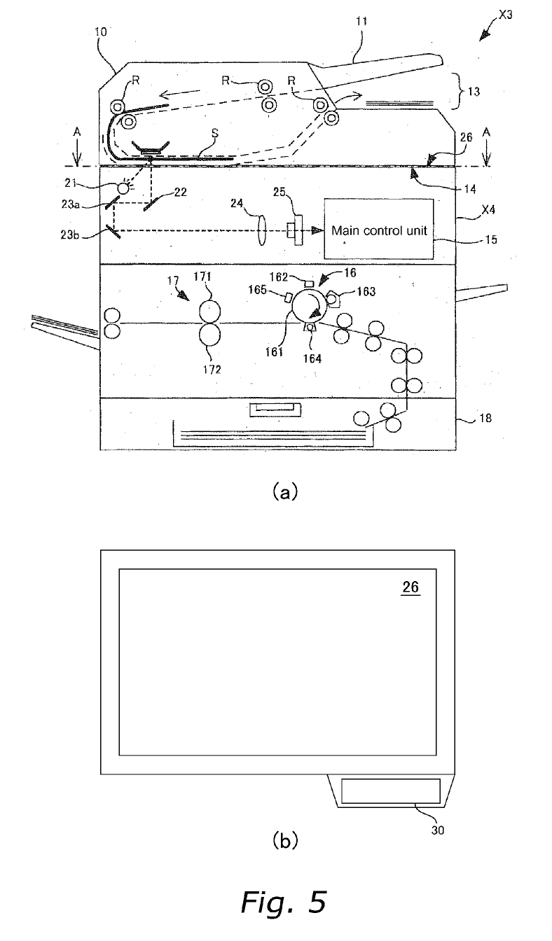

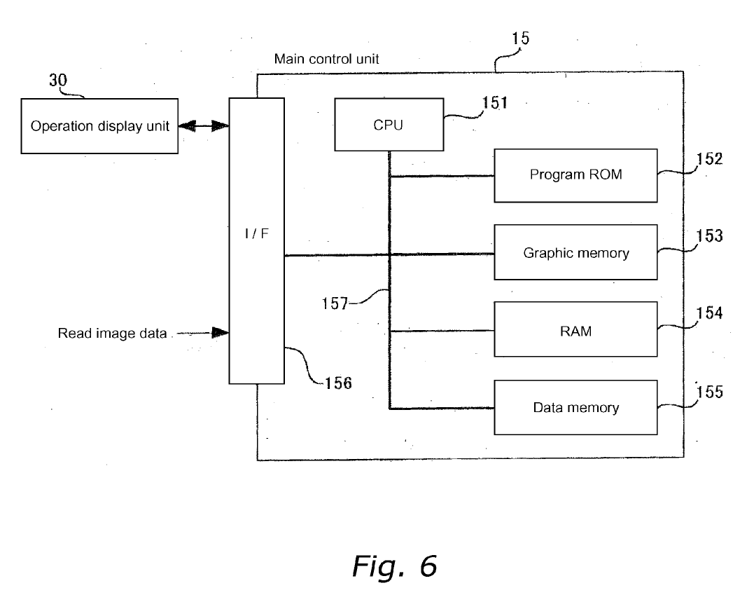

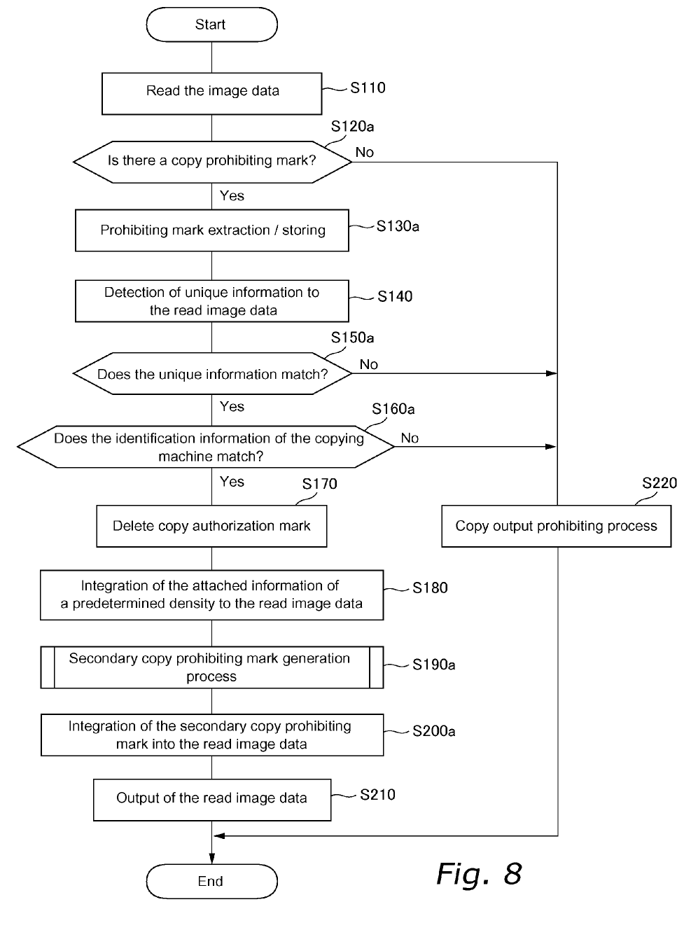

A description will next be given using FIG. 5 through FIG. 8 of a copying machine X4 (one example of an image forming device) that equips a scanning device X3 (one example of an image reading device) that relates to the second embodiment of the present invention. A description will be given herein of an example for authorizing or prohibiting copy output depending on whether a copy authorization mark or a copy prohibition mark is included on the read document image. FIG. 5 is a schematic cross sectional drawing which describes the schematic composition of the copying machine X4; and FIG. 6 a block diagram that shows the schematic composition of the main control unit of the copying machine X4; and FIG. 7 is a flowchart which describes one example of the order of the copy authorization determination process executed by the CPU of the main control unit; and FIG. 8 is a flowchart which describes another example of the order of the copy authorization determination process.

A description will be given first using FIG. 5 of an outline of the entire composition of the copying machine X4 that relates to the second embodiment of the present invention. FIG. 5(a) is a frontal cross sectional drawing of the copying machine X4, and (b) is a plane figure of A-A shown by arrows of (a). Moreover, a description will be given of an example of the copying machine X4 as one example of the image forming device in the second embodiment of the present invention, and without particular restriction to this, a multi-function device (MFP) which provides various functions including, for example, copy functionality, facsimile functionality, scanning functionality, and network printing functionality may also be included.

The copying machine X4 as shown in FIG. 5, as a general classification, is constructed by providing a scanning device X3 which reads the document image, an automatic document feeder 10 (hereinafter called “ADF 10”) arranged on top of the scanning device X3, operation display unit 30 attached to the front side, an image formation unit 16 and fusing device 17 arranged beneath the scanning device X3, a feeding cassette 18 arranged below, and a main control unit 15 for generally controlling the copying machine X4 including all parts.

The document S set in the document setting unit 11 of the ADF 10 is fed one sheet at a time in order through a plurality of feeding rollers and sent in the duplicate scanning direction passing through the predetermined reading position on the contact glass 26, and then discharged to the document discharge unit 13.

A light is irradiated by the exposure device 21 onto the document S which moves in the duplicate scanning direction over the predetermined reading position on the contact glass 26, and reflected light from the document S is detected by the CCD 25 after being directed to the optical lens 24 through the light guiding mirrors 22, 23a , and 23b and focused (converged) by the optical lens 24. The light detected by the CCD 25 is converted into an electronic signal allowing the image data to be recognized by the main control unit 15 based on the converted electronic signal. The main control unit 15 executes the imaging process of the copy authorization determination process and the like to be described hereafter on the image data read in the manner described above.

The image formation unit 16 is constructed of known essential elements for image formation composition such as a photo-sensitive drum 161, charging unit 162, developing device 163, transcribing device 164, and cleaning device 165. The recording paper where the toner image is transcribed by the transcribing device 164 of the image formation unit 16 is transported to the fusing device 17 arranged at the downstream side of the feed direction and passes between the fuser roller 171 (with an embedded fusing heater) and an opposing pressure roller 172 of the fusing device 17, where the toner image on the recording paper is fused and fixed by the heat of the fuser roller 171.

An operation display unit 30 (see FIG. 1(b)) is arranged at the front side of the copying machine X4 in order to display predetermined information or input settings for various functions in the copying machine X4. The operation display unit 30 is equipped with an operation input means such as a pressing button switch and ten key or the like, as well as a display means such as a liquid crystal display.

In the event that the copying machine X4 requires a login input by the user in order to use the copying machine X4, the user will operate from the operation display unit 30 to input their personal user ID code which is one example of login information.

The main control unit 15, as shown in the block diagram FIG. 6, is constructed on an internal bus 157 by the connection of known control unit mechanisms such as a CPU 151, a program ROM 152 which stores the control program for executing the copy authorization process and the like to be described hereafter, graphic memory 153 which stores or temporarily saves the input image data, RAM 154 which is used as the work area for the imaging process, data memory 155 which stores various data, and external I/F 156.

In the main control unit 15, the CPU 151 reads the control program stored in the ROM and performs the copy authorization process by executing the calculation process according to the read control program. A description will be given hereafter of the copy authorization process.

A description will be given herein using the flowchart in FIG. 7 as one example of the order of the copy authorization determination process executed by the CPU 151 of the main control unit 15. The copy authorization determination process begins from step S110 after the copy start operation is initiated in the copying machine X4.

After the copy start operation is initiated by the operator, the mage data of the document is read by the scanning device X3 at step S110; and thereafter, during document imaging of the read image, a determination process (copy guard information determination process) is performed by the CPU 151 (S120) as to whether the copy authorization mark is included. This determination process is performed depending on whether the copy authorization mark is attached or not in the predetermined areas (area P1, P2, P3, etc. in FIG. 4). Moreover, the CPU 151 which performs copy guard information determination process in this manner at this time, or a main control unit 15 having such CPU 151, corresponds to the copy guard information determination means.

If the copy authorization mark is determined here not to be included, the document is recognized to be a copy prohibited document, and subsequent copy action is terminated and the copy output prohibition process (corresponding to the copy guard process) of step S220 is executed. More specifically, deletion of the read image data process, draft printing process, and solid black printing process (one example of a copy guard process) is executed.

If the copy authorization mark is determined to be included at step S120, then the process for determining the legality of the copy authorization mark (legality determination process) is executed by executing the process of steps S130˜S160 to be described hereafter.

In other words, at step S1 30, the copy authorization mark is extracted from the image data by the CPU 151 and temporarily saved in the data memory 155 (FIG. 6). At step S140, unique information of at least the image data (the unique information at this time corresponds to the information for determining legality) is computed (detected) by the CPU 151 from the read image data. For further explanation of the above unique information, please see the description given in the first embodiment given above. Moreover, the CPU 151 which executes a process to compute unique information at this time, or a main control unit 15 having such CPU 151, corresponds to the information detection means for determining legality.

After computing the unique information, a determination is performed in the next step S150 by the CPU 151 as to whether the unique information computed in step S140 matches with the unique information that is included in the copy authorization mark. If it is determined here that it does not match, the process proceeds to step S220 and the previously described copy output prohibition process is executed; but if it is determined to match, then the process proceeds to step S160.

After the process proceeds to step S160, a determination is performed here by the CPU 151 as to whether the identification information of the predetermined copying machine or the like included in the copy authorization mark matches with the identification information of the copying machine X4. If it is determined at this time that the identification information does not match, the process proceeds to step S220 and executes the previously described copy output prohibition process; but if it is determined that it matches, the process proceeds to step S170.

In this way, the copy authorization mark is determined to be legal when both the unique information and the identification information match. Moreover, a CPU 151 which performs a legality determination process in this manner at this time, or a main control unit 15 having such CPU 151, corresponds to the legality determination means.

After it is determined by the legality determination process that the copy authorization mark is legal, a process is next performed once to delete the copy authorization mark from the image data (S170) prior to executing the printing output process of the image data; and a process for integrating and attaching the attached information in a predetermined density to the image data is executed thereafter (S180). Examples of this attached information include, for instance, copy output date, user ID code of the operator performing the copy, the number of copies output, or the like. Of course, it is not limited to these. This type of integration and attachment process of attached information is performed to differentiate the unique information of the read image data from the unique information of the document.

After integrating and attaching the attached information, a process is executed next in step S190 for generating a secondary copy authorization mark that includes the unique information of the image data having the attached information attached. Of course, this secondary copy authorization mark may also include the identification information of the copying machine X4. Next, after executing the process for integrating and attaching the secondary copy authorization mark (S200) generated on the copy output image data, the image data having the secondary copy authorization mark attached is copy output (S210). Moreover, because the process content for each of the processes in steps S190, S200, and S210 are essentially the same as the processes in steps S20, S30, and S40 in FIG. 2 described in the first embodiment above, although the process subject differs, the descriptions thereof will be omitted herein. Further, the process for copy output through the process of steps S170˜S210 after it is determined that the copy authorization mark is legal, is one example of the copy guard process.

In this way, the legality of the copy guard information can be determined even when reading a document image having temporarily cut copy guard information from another document, pasted thereon because the legality of the copy authorization mark is determined by comparing unique information of the image data. Subsequent processing for a document image denied in this manner can be terminated (cancelled), or such read image data can be deleted or the like enabling the effective prevention of illegal copies based on illegally read image data. In this way, more high performance copy guard functionality can be realized.

The above description provides an explanation of an example for determining whether a copy authorization mark is attached to read image data, but it is obvious that an example is also possible for determining either an authorization or prohibition copy output by determining whether a copy prohibition mark is attached and determining the legality of this copy prohibition mark. A description will be given herein using the flowchart in FIG. 8 for the order of the copy authorization determination process for determining authorization of the copy output by determining the legality of the copy prohibition mark. Moreover, for those processes of the same content as the copy authorization determination process shown in the flowchart in FIG. 7, the same reference symbols will be attached while omitting the detailed descriptions thereof.

After the copy start operation is initiated and the image data of the document is read (S110), a determination process is performed (S120a ) thereafter during the read document imaging process, as to whether a copy prohibition mark is included. If it is determined here that a copy prohibition mark is not included, the document is recognized as not a copy prohibited document and the process proceeds to step S210 and normal copy output processing is completed. Conversely, if it is determined at step S120a that the copy prohibition mark is included, then the copy prohibition mark is next extracted from the image data by the CPU 151 at step S130a and temporarily saved in the data memory 155 (FIG. 6). Further, unique information of the image data is computed (detected) in step S140.

After the unique information is computed, a determination is performed next at step S150a by the CPU 151 as to whether the unique information computed at step S140 matches with the unique information included on the copy prohibition mark. If it is determined here not to match, the process proceeds to step S170 to be described hereafter. If it is determined to match, then a determination is performed at the next step S160a by the CPU 151 as to whether the identification information of the predetermined copying machine that includes the copy prohibition mark matches with the identification information of the copying machine X4. If it is determined at this time that the identification information matches, then the legality of the copy prohibition mark is recognized; in other words, the document is recognized to be a copy prohibited document, and the subsequent process proceeds to step S220 where the copy output prohibition process is executed. If it is determined that the identification information does not match, the process proceeds to step S170.

After the process proceeds to step S170, a process is executed to delete once the copy prohibition mark from the image data (S170) and a process is executed to integrate and attach the attached information to the image data (S180) and a process is executed for generating the secondary copy prohibition mark that includes unique information of the image data having the attached information attached (S90) prior to executing the printout process of the image data. Next, after executing the process for integrating and attaching the generated secondary copy prohibiting mark to the copy output image data (S200a ), the image data having a secondary copy authorization mark integrated and attached is copied (S210).

Moreover, there is the problem with the copy authorization determination process described above in which copy output can be executed by the identification information not matching even though the unique information of the image data having the copy prohibition mark attached matches, but this problem can be controlled by using the copy authorization mark in conjunction with the copy prohibition mark.

### Third Embodiment

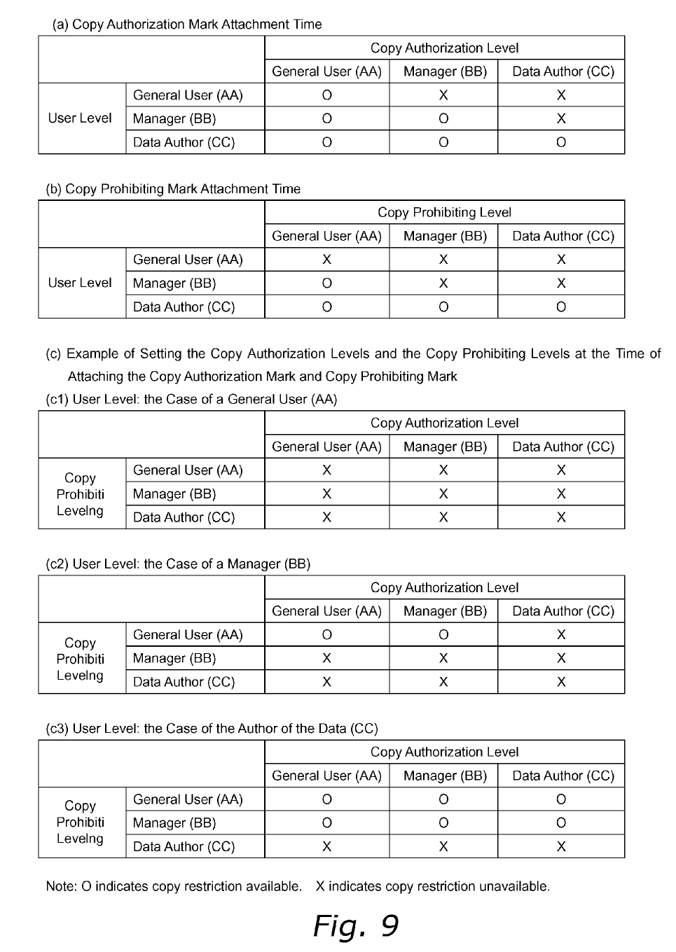

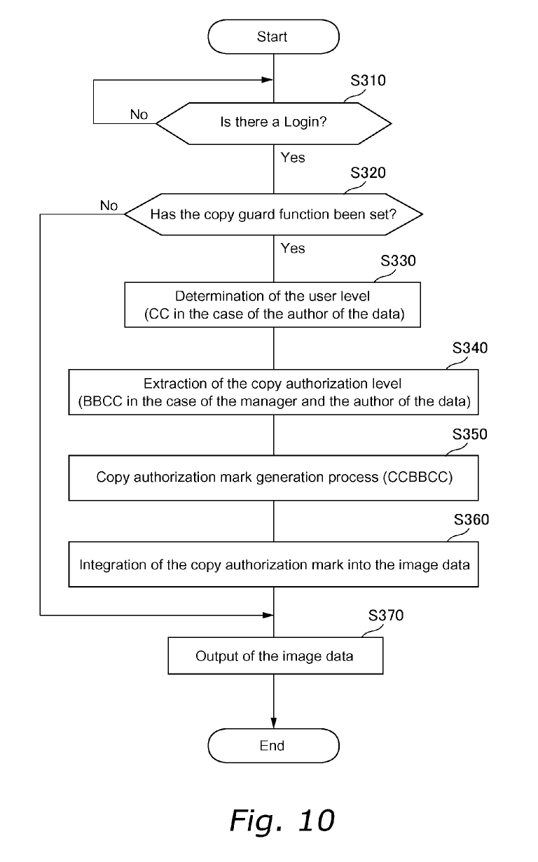

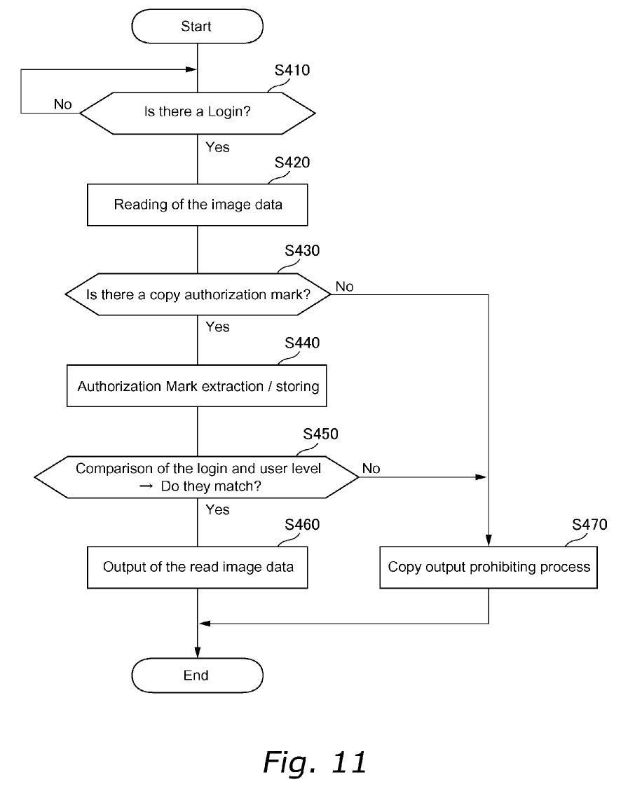

A description will be given hereafter using FIG. 9 through FIG. 11 of the third embodiment of the present invention. FIG. 9 herein is a table diagram regulating the copy authorization levels and the copy prohibition levels according to the user level; and FIG. 10 is a flowchart which describes the order of the modified example of the copy authorization mark attachment process; and FIG. 11 is a flowchart which describes the order of the modified example of the copy authorization determination process.

This third embodiment will herein provide a description of a modified example of the copy authorization mark attachment process described in the first embodiment above (FIG. 2) and a description of a modified example of the copy authorization process described in the second embodiment above. Moreover, unless otherwise referenced, the description of the system configuration and hardware composition in the present third embodiment herein will be omitted as there is no change to system X in the first embodiment and the scanning device X3 and copying machine X4 in the second embodiment.

Moreover, the points of disparity in this third embodiment to the first and second embodiments are the points used on the table shown in FIG. 9 for the copy authorization mark attachment process and the copy authorization determination process. A description will first be given hereinafter of the table of FIG. 9.

FIG. 9, as a general classification, is divided into Table (a) which is used for determining the advisability of attaching the copy authorization mark at the time of attaching the copy authorization mark; Table (b) which is used for determining the advisability of attaching the copy prohibition mark at the time of attaching the copy prohibition mark; and Table (c) which shows the setting example of the copy authorization level and the copy prohibition level. These tables are saved in advance within the HDD 112 (FIG. 1) of the terminal device X1 in system X.

A description is given herein with reference to Table (a).

Table (a) is separated into user level items and copy authorization level items. The user level indicates the rank of the user, and in this embodiment, rank is assigned in order of author of the data, manager (manager of the data), and general user. The copy authorization levels indicate the subjects which have the ability to restrict copy output by the ranking assigned to users. This indicates, for example, that when a person who sets the copy guard function in the terminal device X1 or the copying machine X4 is the author of the image data, a restriction for advisability of copy output by any user can be implemented because any of the general user, manager (manager of the data), and author of the data are recorded by the mark “O” in Table (a). Further, this indicates that when the person who sets the copy guard function is the manager of the image data, a copy output restriction can be placed on the general user and the manager (manager of the data) because these users are recorded by the “O” in Table (a); however, since the author of the data is recorded as an “X”, a copy output restriction cannot be placed on the author of the data. In other words, this indicates that the manager cannot set copy authorization or non-authorization against the author of the data. In the same manner, this identifies that a copy output restriction can only be placed on general users when the person setting the copy guard function is a general user. Respective identification codes are attached to each of the differentiated user levels, for example, “AA” assumes a general user, “BB” assumes a manger, and “CC” assumes the author of the data. Although simple code examples are used here to describe the identification codes, they are of course not limited to these. In addition, although the user levels are divided into three classifications, further detailed classifications are also possible.

Moreover, Table (b) shows the user levels at the time of setting the copy prohibition mark as well as the copy prohibition levels that correspond to the copy authorization levels above; and because these are fundamentally the same as those of Table (a), the descriptions thereof are omitted.

Table (c), meanwhile, shows the setting example of the copy authorization levels and copy prohibition levels when attaching the copy authorization mark and copy prohibition mark; and (c1) is a table of when the user level is a general user, (c2) is a table of when the user level is a manager, and (c3) is a table of when the user level is the author of the data.

Table (c1) indicates, for example, that copying by a general user is completely prohibited when the user level is a general user. Table (c2) further indicates that when the user level is a manager, copying is possible when the copy authorization level is a manager or lower and the copy prohibition level is a general user. Table (c3) further indicates that when the user level is the author of the data, copying is possible when the copy authorization level is the author of the data or lower and the copy prohibition level is a manager or lower.

A description will be given hereafter using the flowchart in FIG. 10 for the order of the copy authorization mark attachment process (modified example) executed by the CPU 115 of the terminal device X1 in system X. The process begins from step S310.

At step S310, a process is executed for determining whether a login is input to the printer driver by the operator. More specifically, login is performed by entering a user ID according to a request from the printer X2 or a request from the printer server not shown in the drawing, when setting the printer X2 which requests a login as the printing output device, and a user authentication process is executed to authenticate the operator by determining whether the input user ID code matches with the user registration information (corresponding to the user information) registered (stored) in advance in the printer server. If the input user ID code matches, the login is recognized, while if it does not match, the login is not recognized and use of the printer X2 is restricted. Moreover, the ID code input at the time of the login entry is temporarily saved in the HDD 112 (FIG. 1) until logout.

After the login input from the user is confirmed at step S310, a determination is performed next at step S320 as to whether the copy guard function is set or not in the printer driver 113 (same process as S10 in FIG. 2). The determination of the existence of settings for the copy guard function at this time is a function which sets the advisability of generating the copy authorization information to be described hereafter which is one example of copy output restriction information, and which corresponds to the copy output restriction information generation advisability setting function of the printer driver 113. If it is determined here that the copy guard function is not set, the process proceeds to step S370, and the image data is output to the printer X2 without attaching (integrating) the copy authorization mark to the image data and normal print out is executed.

Conversely, if it is determined that the copy guard function is set, the process proceeds to step S330. At this step S330, the determination process is executed by the CPU 115 for the user levels based on the user ID input at the time of login. More specifically, it is determined based on the user ID code whether the user (i.e. the person logging-in) performing the current printing operation corresponds to any of a general user, manager, or author of the data. Although the description below depicts the user as the author of the data as a matter of convenience, it goes without saying that, of course, the same process can be undertaken with a manager and a general user when enabling the treatment of image data by someone other than the author of the data.

At the following step S340, the copy authorization level is extracted. More specifically, the extracted copy authorization level is determined by whether any of the user levels are selected as subjects given copy authorization in the printer driver of the terminal device X1. Since the present embodiment describes an example of the process for attaching a copy authorization mark when the user is the author of the data, setting items are established in the printer driver for each individual user level in order to enable settings to attach restrictions for the advisability of copy authorization for all as shown in Table (a) of FIG. 9 for general users, managers, and the author of the data himself. The present embodiment describes an example of where the manager and the author of the data himself are established as subjects for data authorization by the author of the data while a general user is not established as a subject for copy authorization. Therefore, the author of the data and the manager are extracted as subjects for copy authorization accordingly at this step S340.

At step S350, the copy authorization mark is generated using the identification code for the user level determined at step S330 (“CC” in the case of the author of the data) and the identification code for the established copy authentication level (“BB” and “CC” in the case of the manager and the author of the data) (the copy authorization mark generated at this time corresponds to the copy output restriction information). Information of, for instance, a combination of each of the identification codes given above “CCBBCC” can also be conceived as an applicable copy authorization mark. Of course, this is not limited to this and can apply to a visible image consisting of, for example, a bar code, encoded symbol or character string or the like, as well as an invisible image such as an electronic watermark. Moreover, the generation of a copy authorization mark is achieved by the copy output restriction information generation function of the printer driver 113.

A process is subsequently executed to integrate and attach the generated copy authorization mark to the printout image data (S360) with the copy authorization integration unit 114 (FIG. 1) of the terminal device X1, and image data is thereafter output to the printer X2 (S370) having the copy authorization mark integrated and attached. Moreover, both of the processes described in step S360 and S370 are the same as the processes in step S30 and S40 of FIG. 2. Although a description is given herein of an example to integrate and attach a copy authorization mark with the copy authorization integration unit 114, an example can of course also be given in which the copy authorization mark is integrated and attached to the image data at the printer X2 side and printout to the printer X2 occurs thereafter.

The copy authorization mark attachment process given above describes an example of being executed at the time of printout by the printer X2 for image data from the terminal device X1; however, this can also apply to the time of attaching a new copy authorization mark to a reproduction at the time the person authorized for copying makes copies with the copying machine X4. In this case, the same functionality is arranged in the copying machine X4 as the copy output restriction information generation advisability setting functionality and the copy output restriction information generation functionality contained in the printer driver of the terminal device X1.

In this case, when the person authorized for copying is, for example, the manager and this manager performs copy output with the copying machine X4, and after logging-in, establishes the subjects set for copy authorization level restriction (general users and the manager himself) on the setting screen embodied on the operation display unit 30 by each of the functions enabling thereafter the attachment of a new copy authorization mark even by the copying machine X4 by executing the processes that follow step S340. Moreover, it goes without saying that, in this case, a new setting is impossible that exceeds the range of the previously established copy authorization level.

A description is provided hereafter using the flowchart in FIG. 11 for the order of the copy authorization determination process (modified example) executed by the CPU 151 of the main control unit 15 of the copying machine X4. The process begins from step S410.

A process is executed at step S410 for determining whether there has been a login input by the copy operator. More specifically, a user authentication process is executed which determines whether the user ID code entered by the operator from the operation display unit 30 (FIG. 6) in reply to the login request from the copying machine X4 matches with the user registration information registered (saved) in advance into the data memory 155 thereby authenticating the operator who is performing the input operation of image data into the copying machine X3. Moreover, the user ID code input for the login entry is temporarily stored in the data memory 155 until logout.

After the login is recognized (Yes side of S410) and the copy start operation is initiated by the operator, the image data of the document is read by the scanning device X3 at step S420 and while imaging the read document, the determination process (copy output restriction information determination process) is subsequently performed by the CPU 151(S420) to determine whether the copy authorization mark generated at step S350 is included or not. Moreover, the CPU 151 which performs the copy output restriction information determination process in this manner at this time, or a main control unit 15 that has this CPU 151, corresponds to the copy output restriction information determination means.

If it is determined here that the copy authorization mark is not included, then the document is recognized as a copy prohibited document and the copy action is subsequently terminated and the copy output prohibition process (corresponding to the copy output restriction process) of step S470 is performed. More specifically, a read image data deletion process, draft printing process, and solid black printing process (any of which are one example of a copy output restriction process) are executed.

If it is determined that the copy authorization mark is included, then a process to determine the advisability of the copy output (copy output advisability determination process) is executed based on the copy authorization mark and the user ID code input at the time of login, by executing the process in steps S440 and S450 to be described below.

In other words, at step S440, a copy authorization mark is extracted first from the image data by the CPU 151 and temporarily stored in the data memory 155 (FIG. 6). Then at step S450, it is determined whether the user level of the operator recognized from the user ID code input at the time of login matches with the copy authorization level included in the copy authorization mark. If it is determined not to match, the process proceeds to step S470 and the copy output prohibition process is executed, while if it is determined to match, the process proceeds to step S460 and the copy output of the image data is executed. Although a general user is prohibited from copying when attempting copy output (identification code: AA) of a document with a copy authorization mark of CCBBCC attached generated at step S350 (FIG. 10) because the identification code AA is not included in the copy authorization mark CCBBCC, copy output is authorized when a manager (identification code: BB) attempts copy output because the identification code BB is included in the copy authorization mark CCBBCC. This means that the information of the person able to copy and the information of the person that is unable to copy are included in the copy authorization mark CCBBCC. In other words, the information to restrict copy output is included in the copy authorization mark.

In this way, if the document has a copy authorization mark (copy output restriction information) attached, the usability can be improved for the user of the document as well as the user of the copy guard functionality setting because copy output authorization and prohibition settings are possible for individual users.

Although the third embodiment provides a description of an example of attaching only a copy authorization mark, a process for attaching a copy prohibition mark or both a copy authorization mark and copy prohibition mark can be executed by following the same process order as described above if referencing Table (b) and Table (c1), (c2), and (c3) of FIG. 9.

### Additional Embodiment

Descriptions of respective and independent embodiments are given in the first through third embodiments, but an embodiment can be conceived which combines the respective embodiments. For example, the copy authorization mark which includes the unique information of the image data described in the first and second embodiments can conceivably be used by the copy authorization mark attachment process (FIG. 10) and copy authorization determination process (FIG. 11) in the third embodiment.

Any terms of degree used herein, such as “substantially”, “about” and “approximately”, mean a reasonable amount of deviation of the modified term such that the end result is not significantly changed. These terms should be construed as including a deviation of at least ±5% of the modified term if this deviation would not negate the meaning of the word it modifies.

This application claims priority to Japanese Patent Application Nos. 2004-347845 and 2004-347855. The entire disclosure of Japanese Patent Application Nos. 2004-347845 and 2004-347855 are hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An image forming device for performing an image forming process to form input image data on recording paper, comprising:
a copy output restriction information attaching means for attaching copy output restriction information to restrict copy output according to predetermined user information onto recording paper in conjunction with the image data at the time of the image forming process.

2. An image forming device according to claim 1, wherein the copy output restriction information includes authority information relating to copy output assigned a rank according to predetermined user information.

3. An image forming device according to claim 1, wherein the copy output restriction information includes unique information to the image data.

4. An image processing system, comprising:
an image forming device for performing an image forming process to form input image data on recording paper; and
an information processing control device for controlling the image forming process in regards to image data output to the image forming device;
wherein the image forming device and/or the information processing control device comprises a copy output restriction information generation means for generating copy output restriction information to restrict copy output according to predetermined user information, and
the image forming device comprises a copy output restriction information attaching means for attaching copy output restriction information generated by the copy output restriction information generation means onto the recording paper in conjunction with the image data at the time of the image forming process.

5. An image processing system according to claim 4, wherein the information processing control device comprises a copy output restriction information generation advisability setting means for setting the advisability of generating copy output restriction information by the copy output restriction information generation means, and the copy output restriction information generation means generates the copy output restriction information according to the setting by the copy output restriction information generation advisability setting means.

6. A storage medium for storing a printer driver executed by the information processing control device for controlling the image forming process in the image forming device, wherein the printer driver causes the information processing control device to execute:
a copy output restriction information generation advisability setting function for setting the advisability of generating copy output restriction information to restrict copy output according to predetermined user information; and
a copy output restriction information generation function for generating the copy output restriction information according to the setting by the copy output restriction information generation advisability setting means.

7. An image reading device controlled to recognize the use of the image reading device only when login information that matches to user information registered in advance is input, comprising:
copy output restriction information determination means for determining whether copy output restriction information is attached to the read image data in order to restrict the copy output according to the user information; and
copy output advisability determination means for determining the advisability of copy output in the image forming device based on the attached copy output restriction information and the input login information when it has been determined that copy output restriction information is attached by the copy output restriction information determination means.

8. An image reading device according to claim 7, wherein the copy output restriction information includes authority information relating to copy output assigned a rank according to the predetermined user information.

9. An image forming device, comprising:
the image reading device according to claim 7; and
a copy output restriction means for executing a copy output restriction process according to the determination result by the copy output advisability determination means in regards to image data read by the image reading device.

10. An image forming device for performing an image forming process to form input image data on recording paper, comprising: a copy guard information attaching means for attaching copy guard information that includes unique information to at least the image data onto recording paper in conjunction with the image data at the time of the image forming process.

11. An image forming device according to claim 10, wherein the copy guard information further includes the identification information of the image forming device.

12. An image forming device according to claim 10, wherein the copy guard information is either single or a plurality of copy prohibition information and/or copy authorization information.

13. An image processing system, comprising:
an image forming device for performing an image forming process to form input image data on recording paper; and
an information processing control device for controlling the image forming process in regards to image data output to the image forming device;
wherein the image forming device and/or the information processing control device comprises a copy guard information generation means for generating copy guard information that includes unique information to at least the image data, and the image forming device comprises a copy guard information attaching means for attaching copy guard information generated by the copy guard information generation means onto recording paper in conjunction with the image data at the time of the image forming process.

14. An image processing system according to claim 13, wherein the information processing control device comprises a copy guard information generation advisability setting means for setting the advisability of generating copy guard information by the copy guard information generation means; and
the copy guard information generation means generates the copy guard information according to the setting by the copy guard information generation advisability setting means.

15. A storage medium for storing a printer driver executed by the information processing control device for controlling the image forming process in the image forming device, wherein the printer driver causes the information processing control device to execute:
a copy guard information generation advisability setting function for setting the advisability of generating copy guard information that includes unique information to at least the image data; and
a copy guard information generation function for generating the copy guard information according to the setting by the copy guard information generation advisability setting means.

16. An image reading device for reading image data of a document by scanning the image printed surface of the document, comprising:
a copy guard information determination means for determining whether copy guard information that includes unique information to at least the image data is attached to the read image data; and
a legality determination means for determining the legality of the copy guard information when it is determined that copy guard information is attached by the copy guard information determination means.

17. An image reading device according to claim 16, further comprising:
an information detection means for determining legality for detecting information for determining legality that includes unique information to at least the image data from the read image data, wherein the legality determination means determines whether unique information included in at least the copy guard information matches respectfully with the legality determination information.

18. An image forming device, comprising:
the image reading device according to claim 16; and
a copy guard processing means that performs a copy guard process according to the determination result by the legality determination means in regards to image data read by the image reading device.

19. An image forming device according to claim 18, further comprising:
a secondary copy guard information generation means for generating secondary copy guard information that differs from the copy guard information in conjunction with deleting the copy guard information attached to the read image data when the image forming process is authorized by the copy guard processing means; and
a secondary copy guard information attaching means for attaching secondary copy guard information generated by the secondary copy guard information generation means onto recording paper in conjunction with the read image data at the time of the image forming process.

20. An image forming device according to claim 19, wherein the secondary copy guard information includes a single or a plurality of at least any unique information to the read image data or identification information of the image forming device.
